(19) United States
(12) Patent Application Publication
(10) Pub. No.: US 2026/0292505 A1
(43) Pub. Date: Sep. 24, 2026

(54) METHODS AND DEVICES FOR SHORT FRAME PROTECTION IN A WIRELESS COMMUNICATION NETWORK

(71) Applicant: Morse Micro Pty. Ltd., Surry Hills NSW (AU)

(72) Inventors: David Scott Goodall, Crows Nest NSW (AU); Henry Stanley Ptasinski, Petaluma, CA (US)

(21) Appl. No.: 19/136,273

(22) PCT Filed: Sep. 4, 2024
(86) PCT No.: PCT/IB2024/058566

§ 371 Date: Jun. 5, 2025

(30) Foreign Application Priority Data
Nov. 1, 2023 (AU) 2023903512

(51) Int. Cl. H04W 12/106; H04W 12/06

(52) U.S. Cl. CPC H04W 12/106; H04W 12/06

(57) ABSTRACT

Systems and techniques are provided for performing wireless communications. In some aspects, a short frame protection method is provided for a short frame transmitted in a wireless communication network. A target transmission time for transmitting the short frame can be determined. An integrity value can be computed for protection of the short frame, based on the target transmission time and using an authentication algorithm. The protection of the short frame can be based on including, within a transmission of the short frame, at least a portion of the integrity value computed by a transmitter of the short frame.

### CROSS-REFERENCE TO RELATED APPLICATIONS

This application claims the benefit of Australian Provisional Patent Application No. 2023903512, filed Nov. 1, 2023, which is hereby incorporated by reference, in its entirety and for all purposes.

### FIELD

The present disclosure generally relates to wireless communications. For example, aspects of the present disclosure are related to short frame protection in a wireless communication network, including sub-gigahertz (S1G) networks.

### BACKGROUND

A wireless network, for example a wireless local area network (WLAN) such as a Wi-Fi (e.g., Institute of Electrical and Electronics Engineers (IEEE) 802.11) network, may include one or more access points (APs) that may communicate with one or more stations (STAs) or mobile devices. The one or more APs may provide a shared wireless communication medium for use by multiple STAs. An AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

Beacon frames are used in IEEE 802.11 based WLANs as management frames. Beacon frames contain all the information about the network. For example, beacon frames can contain or otherwise indicate the configuration of the corresponding network. Beacon frames are transmitted periodically and have a number of functions, including the announcement of the presence of a WLAN, synchronizing the members of a service set, and signaling the presence of buffered data traffic for members of the service set. A WLAN can include one or more APs and STAs. A single AP and an associated set of STAs can be referred to as a Basic Service Set (BSS), which is managed by the AP and is identified by a Service Set Identifier (SSID), as well as to other devices by a basic service set identifier (BSSID), which may be a medium access control (MAC) address of the AP. An AP periodically broadcasts beacon frames to enable STAs within the range of the BSS to establish or maintain a communication with the WLAN. A STA joins a BSS by associating with the AP of the BSS. The AP may be coupled to a network, such as the Internet, which enables STAs associated with the AP to communicate to the network and/or to communicate with each other. Beacon frames are sent periodically by the APs in IEEE 802.11 networks and other wireless technologies to advertise the presence and parameters of the wireless network, as well as for time synchronization purposes. A beacon frame may include or indicate the network name, other information such as security requirements, power save indications, and a timestamp that allows STAs in a power-save mode to remain synchronized with the AP. Beacon frames are generally unencrypted so the network can be discovered by STAs which have not yet joined the network.

Beacon frames that are transmitted without using encryption can be referred to as unprotected beacon frames, where the information included in the unprotected beacon frame is sent in plain text. Any device within range of an AP transmitting unprotected beacon frames may read the information included within the unprotected beacon frame. Due to various security attacks that may be allowed by unprotected beacon frames, IEEE 802.11 beacon packets (e.g., used by the 802.11 Medium Access Control (MAC) or Physical (PHY) layer in the 2.4, 5, and 6 GHz bands) may implement beacon protection in the form of a Message Integrity Code (MIC) that is added to beacon frames. The MIC provides protection against tampering of most fields in the beacon frame, while the beacon frame remains unencrypted. The MIC is calculated over the contents of the beacon frame but with the timestamp field set to all zeros. The real timestamp for the beacon frame is added later at the time of transmission and is not protected by the MIC. The MIC can be included in a Management MIC Element (MME) which is added as the last Information Element (IE) in a beacon frame, just before the frame check sequence field.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication over a wireless communication network such as a Wireless Local Area Network (WLAN). According to at least one illustrative example, a short frame protection method for a short frame transmitted in a wireless communication network is provided, the method comprising, the method including: determining a target transmission time for transmitting the short frame; and computing an integrity value for protection of the short frame, wherein the integrity value is generated based on the target transmission time and using an authentication algorithm, wherein the protection of the short frame is based on including, within a transmission of the short frame, at least a portion of the integrity value computed by a transmitter of the short frame.

In some aspects, the short frame is a management frame, a control frame, or a data frame transmitted in the wireless communication network.

In some aspects, the short frame is a beacon frame; and the target transmission time is a Target Beacon Transmission Time (TBTT) associated with transmitting the beacon frame, or a Target Short Beacon Transmission Time (TSBTT) associated with transmitting the beacon frame.

In some aspects, the method further comprises: generating a protected short frame based on inserting the computed integrity value within the short frame, or appending the computed integrity value to the short frame; and transmitting the protected short frame to one or more stations in the wireless communication network.

In some aspects, the method further comprises: truncating the computed integrity value to thereby obtain a truncated integrity value for inserting within or appending to the short frame, wherein the protected short frame transmitted on the wireless communication network is protected based on the truncated integrity value.

In some aspects, computing the integrity value comprises: dividing a timer value by a beacon interval corresponding to the short frame, to thereby obtain a first calculated value; determining a counter based on taking a ceiling of the first calculated value; and computing the integrity value based on the counter.

In some aspects, the integrity value is a Message Integrity Code (MIC) or a message authentication code.

In some aspects, the authentication algorithm is based on a Broadcast/multicast Integrity Protocol (BIP) for protecting an integrity for group addressed frames.

In some aspects, the target transmission time for transmitting the short frame is independently determined by a transmitter and a receiver of the short frame.

In another illustrative example, a wireless communication device in a wireless communication network is provided, the wireless communication device comprising: a Radio Frequency (RF) receiver and a RF transmitter; a processor, communicatively coupled to the RF receiver and the RF transmitter; and one or more memory banks, communicatively coupled to the processor and storing processor readable codes that, when executed by the processor, is configured for: determining a target transmission time for transmitting a short frame; and computing an integrity value for protection of the short frame, wherein the integrity value is generated based on the target transmission time and using an authentication algorithm, wherein the protection of the short frame is based on including, within a transmission of the short frame, at least a portion of the integrity value computed by a transmitter of the short frame.

In some aspects, the wireless communication device is an Access Point (AP).

In some aspects, the processor is configured to generate a protected short frame based on inserting the computed integrity value within the short frame or appending the computed integrity value to the short frame.

In some aspects, the RF transmitter is configured to transmit the protected short frame in the wireless communication network.

In some aspects, the short frame is a beacon frame; and the target transmission time is a Target Beacon Transmission Time (TBTT) associated with transmitting the beacon frame, or a Target Short Beacon Transmission Time (TSBTT) associated with transmitting the beacon frame.

In some aspects, the integrity value is a Message Integrity Code (MIC) or a message authentication code.

In another illustrative example, a short frame protection method in a wireless communication network is provided, the method including: receiving, by a first network device, a short frame transmitted by a second network device, wherein the received short frame includes information indicative of an integrity value calculated by the second network device based on a target transmission time associated with the short frame; determining, by the first network device, a target transmission time associated with the received short frame; computing, by the first network device, an expected integrity value for the received short frame, wherein the expected integrity value is based on the target transmission time determined by the first network device; and verifying, by the first network device, the received short frame, based on comparing the expected integrity value and the integrity value indicated in the received short frame.

In some aspects, the first network device comprises a station (STA) included in the wireless communication network, and wherein the second network device comprises an Access Point (AP) included in the wireless communication network.

In some aspects, the received short frame is a protected beacon frame; and the target transmission time is a Target Beacon Transmission Time (TBTT) or a Target Short Beacon Transmission Time (TSBTT) associated with transmission of the protected beacon frame by the second network device.

In some aspects, at least a portion of the integrity value calculated by the second network device is included within or appended to the received short frame received by the first network device.

In some aspects, the received short frame includes a truncated integrity value calculated by the second network device.

In some aspects, the integrity value indicated in the received short frame is based on a ceiling of a beacon counter calculation by the second network device; the expected integrity value computed by the first network device is based on a floor of the beacon counter calculation, wherein the first network device and the second network device perform the same beacon counter calculation each using a respective timer value as an input to the same beacon counter calculation. In some aspects, computing the expected integrity value comprises: dividing the respective timer value for the first network device by a beacon interval corresponding to the short frame, to thereby obtain a first calculated value; determining a counter based on taking a floor of the first calculated value; and computing the expected integrity value based on the counter.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following drawing figures:

FIG. 1 is a block diagram illustrating an exemplary wireless communication network;

FIG. 2A is a block diagram of a wireless communication device that can implement a station (STA) or access point (AP), in accordance with some examples;

FIG. 2B is a schematic block diagram of the receiver data flow architecture of the wireless communication device of FIG. 2A, in accordance with some examples;

FIG. 2C is a schematic block diagram of a transmitter data flow architecture that can be used to transmit Radio Frequency (RF) signals over a wireless medium, in accordance with some examples;

FIG. 3 is a diagram illustrating an example format of a Management Message Integrity Code (MIC) Element (MME), in accordance with some examples;

FIG. 4 is a diagram illustrating an example format of a MIC element, in accordance with some examples;

FIG. 5 is a diagram illustrating an example frame format for a sub-gigahertz (S1G) beacon frame using broadcast/multicast integrity protocol (BIP) compact encapsulation (BCE), in accordance with some examples;

FIG. 6 is a diagram illustrating an example format of a High Efficiency (HE) Ranging Null Data Packet (NDP) frame with secure HE-Long Training Fields (HE-LTFs), in accordance with some examples;

FIG. 7 is a diagram illustrating an example frame format corresponding to an Institute of Electrical and Electronics Engineers (IEEE) 802.11ah 2-Megahertz (MHz) Null Data Packet (NDP) Paging frame, where a truncated integrity value is carried on reserved bits of the frame, in accordance with some examples;

FIG. 8 is a diagram illustrating an example frame format corresponding to an IEEE 802.11ah 1-MHz NDP Paging frame with a reserved bit used to signal that a truncated integrity value is appended to the frame, in accordance with some examples;

FIG. 9A is a signaling diagram illustrating an example of IEEE 802.11 group key exchange using a group key handshake, in accordance with some examples;

FIG. 9B is a diagram illustrating an example format of a Beacon Integrity Group Temporal Key (BIGTK) subelement including a BIPN field that can be used to implement a BIP replay counter and/or packet number indication corresponding to a number of Target Short Beacon Transmission Times (TSBTTs) or Target Beacon Transmission Times (TBTTs) since a Time Synchronization Function (TSF) time 0, in accordance with some examples;

FIG. 10 is a flow diagram of an example process for adaptive root mesh configuration for a first mesh node in a mesh network, in accordance with some examples; and

FIG. 11 is a block diagram illustrating an example of a computing system for implementing certain aspects described herein, in accordance with some examples.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

### Overview

A Wireless Local Area Network (WLAN) is a wireless communication network that uses high-frequency radio waves (e.g., radio frequency (RF) waves) for connecting devices within a limited area. Most WLANs are based on one or more of the various Institute of Electrical and Electronics Engineers (IEEE) 802.11 Wi-Fi standards. Devices connected to a WLAN may be implemented as either an Access Point (AP) providing services or a client station (STA). A Basic Service Set (BSS) typically contains an AP and a group of STAs wirelessly communicating at the physical layer level. For example, a respective AP and an associated set of STAs (e.g., a set of STAs associated with the respective AP) can comprise one BSS of the WLAN, where the BSS is managed by the AP included within the BSS. The BSS can be identified to users by a corresponding Service Set Identifier (SSID). An AP can be configured as a master or primary device that is used to configure and maintain the network (e.g., the Wi-Fi WLAN, etc.). The AP associates all valid STAs and periodically transmits beacon frames to indicate various network information and/or network details to the BSS.

While mobile Wi-Fi STAs offer the convenience of wireless connectivity, there are several challenges that can affect the overall network performance and user experience associated with the wireless connectivity of the Wi-Fi STAs to a Wi-Fi network. For example, the challenges can include maintaining a proper signal strength and coverage, preventing network congestions, and resolving interferences, among various others. Mobile Wi-Fi STAs rely on the wireless network availability and the strength of Wi-Fi signals from APs or hotspot devices. However, in areas with weak or limited wireless communication coverage, the signal strength may be insufficient for stable connections to be established or maintained between a STA and an AP or other hotspot device. Unstable connections to a STA can result in slow data speeds, frequent disconnections, and/or difficulty in establishing a connection, among various others.

In crowded or densely populated areas, a Wi-Fi network can become congested as too many devices attempt to connect simultaneously to the same AP (e.g., with the congestion based on the limited overall bandwidth and airtime available for communications to or from the given AP and the set of STAs associated with the given AP). Such congestion may lead to one or more of a reduction in overall data speeds to the STAs and on the Wi-Fi WLAN, increased latency, and/or intermittent connectivity for mobile Wi-Fi STAs, among various others. Additionally, mobile Wi-Fi STAs can experience interference from various sources, such as the interferences from other wireless communication networks operating on the same or overlapped channel(s). For instance, co-channel interference can occur when multiple networks or devices operate on the same channel; adjacent channel interference can occur when signals from nearby channels spill over into the operating channel of the Wi-Fi STA; non-Wi-Fi interference can be caused by other devices operating in the same frequency bands (e.g., microwave ovens, cordless phones, Bluetooth devices, IoT devices, etc.); multipath interference can be caused by the reflection of RF waves that result in multiple versions of the same signal arriving at the receiver at different times, signal fading, reduced data rates, etc.

IEEE 802.11ah, also referred to as Wi-Fi HaLow, is a wireless networking protocol that uses a sub-gigahertz (S1G) wireless radio to provide low power consumption and long distance wireless communication. Wi-Fi HaLow devices operate in the license-exempt ISM (Industrial, Scientific, and Medical) frequency bands under one Gigahertz (GHz). A Wi-Fi HaLow AP can provide connectivity to thousands of STAs within a network coverage of approximately a one-kilometer radius. Wi-Fi HaLow supports various bandwidths, including 1 MHz, 2 MHz, 4 MHz, 8 MHz, and 16 MHz, which are approximately one order of magnitude narrower (e.g., 10 times narrower) than the bandwidths utilized by the IEEE 802.11ac (Wi-Fi 5) standard. Moreover, the symbol duration for IEEE 802.11ah Wi-Fi HaLow operating at a 2 MHz bandwidth can be up to 10 times longer than the comparable symbol duration for IEEE 802.11ac Wi-Fi 5. As such, Wi-Fi HaLow networks have both significantly narrower bandwidths and significantly longer symbol durations within that narrower bandwidth, as compared to a Wi-Fi 5 or other more recent Wi-Fi network. Accordingly, airtime is more limited as a whole, and the airtime used for each individual data transmission in a HaLow network is also much longer as compared to a Wi-Fi 5 network. Although Wi-Fi HaLow STAs can be grouped to minimize contention on the air media, effective and efficient radio resource management methods for preventing network congestion are still needed for Wi-Fi HaLow networks.

Aspects of the present invention provide novel and effective methods for short frame protection in a wireless communication network. For example, the systems and techniques described herein can be used to provide improved short frame protection in a wireless communication network, including short frame protection with a reduced overhead and/or short frame protection for various communications associated with Wi-Fi and/or S1G WLANs, including Wi-Fi HaLow networks. In some embodiments, the systems and techniques can be used to provide short frame protection for S1G beacon frames and/or various other management frames transmitted in an S1G network. For example, the systems and techniques can be used to implement and/or enhance broadcast/multicast integrity protocol (BIP) to support the protection of S1G beacon frames, among various other short frames in an S1G network.

In some embodiments of the present invention, the short frame protection method can include determining a target transmission time for transmitting a short frame, and generating an integrity value based on the target transmission time for the short frame. The integrity value can be generated (e.g., calculated) using an authentication algorithm with at least the target transmission time as input. At least a portion of an integrity value determined by a transmitter of the short frame (e.g., a transmitting entity for the short frame, such as an AP, etc.) is included in the short frame. Some examples of the short frame are management frames, control frames, and data frames. For example, the short frame can be a beacon frame, and the target transmission time can be a Target Beacon Transmission Time (TBTT), or a Target Short Beacon Transmission Time (TSBTT).

The target transmission time (e.g., TBTT, TSBTT, etc.) can comprise time information known by both the transmitter and receiver of the beacon frame, and can be used to implement the short frame protection described herein based on both the transmitter and the receiver using the target transmission time of a beacon frame to perform respective calculations of the corresponding integrity value for the beacon frame. For example, the transmitter can transmit a beacon frame including integrity value information determined based on the target transmission time (e.g., TBTT, TSBTT, etc.) for the first beacon. The receiver can determine or obtain the same or similar target transmission time for the first beacon, and the receiver can calculate a corresponding integrity value (e.g., an expected integrity value, a receiver-side integrity value, etc.) for the reception of the first beacon. The receiver can receive the first beacon from the transmitter, and can compare the integrity value included in the first beacon to the expected integrity value calculated by the receiver using the target transmission time of the first beacon.

In some cases, the transmitter inserts or appends the computed integrity value in the short frame before sending the short frame with the included integrity value to one or more stations. In some embodiments, the transmitter may truncate the integrity value before inserting or appending to the short frame. For example, the transmitter may calculate an integrity value having a first length, and can perform truncation to obtain a truncated integrity value having a second length that is less than the first length. The shorter, truncated integrity value may be inserted or appended to the short frame for transmission by the transmitter. In some embodiments, the transmitter divides a timer value by a beacon interval and takes a ceiling to generate a counter, and computes the transmitter-side integrity value using the ceiling-based counter. An example of the timer value is a Time Synchronization Function (TSF) timer value. An embodiment of the transmitter calculates the integrity value for the current TBTT by Ceil (TSF/(1024*beacon interval)), or the transmitter calculates the integrity value for the current TSBTT by Ceil (TSF/(1024*short beacon interval)), where the TSF timer value is in microseconds while the beacon interval/short beacon interval is in Time Units (TUs). Similarly, the receiver calculates the integrity value for the current TBTT by Floor (TSF/(1024*beacon interval)), or it calculates the integrity value for the current TSBTT by Floor (TSF/(1024*short beacon interval)). In cases when the beacon interval or short beacon interval is defined in microseconds, the transmitter and the receiver may derive the integrity values by dividing the TSF in microseconds by the configured beacon interval in microseconds. The receiver of the short frame receives the short frame, and verifies the short frame by comparing the computed integrity value determined by the receiver (e.g., expected integrity value) and the integrity value included in the short frame (e.g., actual or received integrity value). In some aspects, the receiver of the short frame divides a timer value by a beacon interval and takes a floor to generate a counter, and computes the receiver-side integrity value using the floor-based counter.

In some embodiments, the systems and techniques described herein for short frame protection can utilize an integrity value comprising a message integrity code (MIC) or a message authentication code. Some embodiments of the authentication algorithm are based on a CCMP Counter Mode with Cipher Block Chaining Message Authentication Code Protocol, or CCM Protocol, (CCMP) protecting an integrity of a Medium Access Control Protocol Data Unit (MPDU) data field and a selected portion of an MPDU header. Some embodiments of the authentication algorithm are based on a Broadcast/multicast Integrity Protocol (BIP) for protecting an integrity for group addressed management frames. The target transmission time for transmitting the short frame can be independently determined by a transmitter and a receiver of the short frame. In some embodiments, the short frame is a Null Data Packet (NDP) frame used to signal whether an AP has buffered data for a STA, and the target transmission time used to compute the integrity value is a TBTT. In some aspects, the short frame protection method can further include dividing a timer into small windows and using a finer grained target transmission time for computing the integrity value.

An aspect of the invention can correspond to a wireless communication device in a wireless communication network, where the wireless communication devices include a Radio Frequency (RF) receiver and a RF transmitter, a processor, and one or more memory banks. The one or more memory banks are communicatively coupled to the processor and store processor readable codes configured for determining a target transmission time for transmitting a short frame, and computing an integrity value based on the target transmission time using an authentication algorithm. At least a portion of the integrity value computed by a transmitter is included in the short frame. The wireless communication device is an AP according to some embodiments, where the processor is configured to insert or append the computed integrity value in the short frame, and the RF transmitter is configured to transmit the short frame in the wireless communication network. The wireless communication device is a STA according to some embodiments, where the RF receiver receives the short frame and the processor is configured to verify the short frame by comparing the computed integrity value with the integrity value included in the short frame.

### Example Embodiments

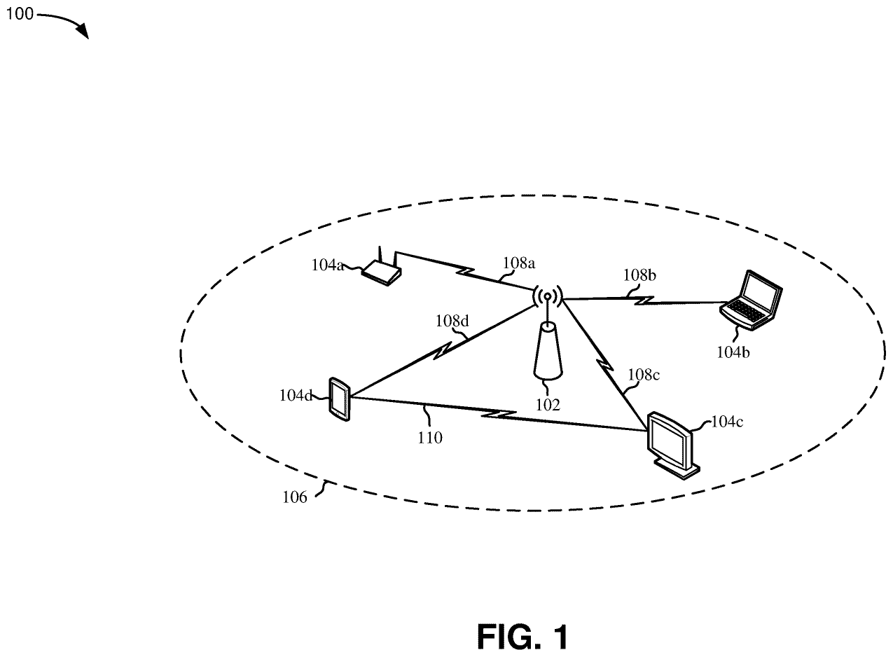

FIG. 1 is a block diagram illustrating an exemplary wireless communication network 100. In some aspects, the wireless communication network 100 can be an example of a Wireless Local Area Network (WLAN). As used herein, a WLAN may be a Wi-Fi network. In some examples, the WLAN 100 can be a network implementing at least one of the IEEE 802.11 family of wireless communication protocol standards (e.g., such as that defined by the IEEE 802.11-2020 specification or amendments thereof including, but not limited to, 802.11ah, 802.11ay, 802.11ax, 802.11az, 802.11ba and 802.11be). The WLAN 100 may include at least one AP 102 and multiple associated STAs 104. For example, the STAs 104 can include a first STA 104a, a second STA 104b, a third STA 104c, a fourth STA 104d, etc. While only one AP 102 is shown, the WLAN network 100 also can include multiple APs 102.

Each of the STAs 104a-104d may be referred to as a Mobile Station (MS), a mobile device, a mobile handset, a wireless handset, an Access Terminal (AT), a User Equipment (UE), a Subscriber Station (SS), and/or a subscriber unit, among other examples. The STAs 104 may represent various devices such as mobile phones, handheld devices, netbooks, computers, tablet computers, laptops, display devices (e.g., TVs, computer monitors, navigation systems, etc.), music or other audio or stereo devices, remote control devices (“remotes”), printers, kitchen or other household appliances, key fobs (e.g., for Passive Keyless Entry and Start (PKES) systems), etc.

A single AP 102 and an associated set of STAs 104a-104d may be referred to as a Basic Service Set (BSS), which is managed by the respective AP 102. FIG. 1 additionally shows an example coverage area 106 of the AP 102, which may represent a Basic Service Area (BSA) of the WLAN 100. The BSS may be identified to users by a Service Set Identifier (SSID), as well as to other devices by a Basic Service Set Identifier (BSSID), which may be a Medium Access Control (MAC) address of the AP 102.

The AP 102 periodically broadcasts beacon frames (“beacons”) including the BSSID to enable any STAs (e.g., such as one or more, or all, of the STAs 104a-104d) within wireless range of the AP 102 to associate or re-associate with the AP 102 to establish a respective communication link 108a-108d (e.g., hereinafter also referred to as a “Wi-Fi link”). For example, the first STA 104a can establish a respective communication link 108a with the AP 102, the second STA 104b can establish a respective communication link 108b with the AP 102, the third STA 104c can establish a respective communication link 108c with the AP 102, the fourth STA 104d can establish a respective communication link 108d with the AP 102, etc. The STAs 104a-104d may additionally use the beacon frames broadcast by AP 102 to maintain the respective communication link 108a-108d with the AP 102. For example, the beacons can include an identification of a primary channel used by the respective AP 102 as well as a timing synchronization function for establishing or maintaining timing synchronization with the AP 102. The AP 102 may provide access to external networks to various STAs in the WLAN via respective communication links 108.

To establish the communication links 108a-108d with an AP 102, each of the respective STAs 104a-104d can perform passive or active scanning operations (“scans”) on frequency channels in one or more frequency bands. For example, to perform passive scanning, each of the STAs 104a-104d listens for beacons that are transmitted by the AP 102 at a periodic time interval referred to as the Target Beacon Transmission Time (TBTT). The TBTT can be measured in Time Units (TUs). In some examples, one TU may be equal to 1024 microseconds (μs). In some examples, the TBTT can have a default value of 102.4 milliseconds (ms). To perform active scanning, each of the STAs 104a-104d can generate and sequentially transmit probe requests on each channel to be scanned and listens for probe responses from the AP 102. Each of the STAs 104a-104d may be configured to identify or select an AP 102 with which to associate (e.g., based on the scanning information obtained through the passive or active scans), and to perform authentication and association operations to establish a respective communication link 108a-108d with the selected AP 102. The AP 102 assigns an Association Identifier (AID) to each of the STAs 104a-104d at the culmination of the association operations, which the AP 102 uses to track the STAs 104a-104d.

In some cases, one or more of the STAs 104a-104d may have the opportunity to select one of many BSSs within range of the STA or to select among multiple APs 102 that together form an Extended Service Set (ESS) including multiple connected BSSs. An extended network station associated with the WLAN 100 may be connected to a wired or wireless distribution system that may allow multiple APs 102 to be connected in an ESS. In some examples, one or more of the STAs 104a-104d can be covered by more than one AP 102 and can associate with different APs 102 at different times for transmissions. After association with an AP 102, one or more of the STAs 104a-104d also may be configured to periodically scan its surroundings to find a more suitable AP with which to associate. For example, a given one of the STAs 104a-104d that is moving away from its associated AP 102 may perform a “roaming” scan to find another AP having more desirable network characteristics (e.g., such as a greater Received Signal Strength Indicator (RSSI), a reduced traffic load, etc.).

In some cases, the STAs 104a-104d may form networks without APs 102 or other equipment other than the STAs 104a-104d themselves. One example of such a network is an ad hoc network. Some examples of an ad hoc network are mesh networks and peer-to-peer (P2P) networks. In some cases, ad hoc networks may be implemented within a larger wireless network In such implementations, while the STAs 104a-104d may be capable of communicating with each other through the AP 102 using the respective communication links 108a-108d, the STAs 104a-104d, the STAs may also communicate directly with each other using direct wireless links 110. In some examples, two STAs may communicate via a direct communication link 110 regardless of whether both STAs 104 are associated with and served by the same AP 102. In such an ad hoc system, one or more of the STAs 104a-104d may assume the role filled by the AP 102 in a BSS. Such a STA may be referred to as a Group Owner (GO) and may coordinate transmissions within the ad hoc network. Examples of direct wireless links 110 can include one or more of Wi-Fi Direct connections, connections established by using a Wi-Fi Tunneled Direct Link Setup (TDLS) link, and other P2P group connections, etc.

The APs 102 and STAs 104a-104d may function and communicate using the respective communication links 108a-108d according to at least one of the IEEE 802.11 wireless communication protocol standards. These standards define the WLAN radio and baseband protocols for the physical (PHY) and Medium Access Control (MAC) layers. For example, the APs 102 and STAs 104a-104d transmit and receive wireless communications to and from one another in the form of PHY Protocol Data Units (PPDUs) or Physical Layer Convergence Protocol (PLCP) PDUs. The APs 102 and STAs 104a-104d in the WLAN 100 may transmit PPDUs over a license or unlicensed spectrum, which may be a portion of spectrum that includes frequency bands traditionally used by Wi-Fi technology, such as the 2.4 GHz band, the 5 GHz band, the 60 GHz band, the 3.6 GHz band, and the sub-1 GHz band. Some implementations of the APs 102 and STAs 104a-104d described herein also may communicate in other frequency bands, such as the 6 GHz band, which may support both licensed and unlicensed communications. The APs 102 and STAs 104a-104d also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11 standards and specifications may be transmitted over frequency bands that are divided into multiple 20 MHz channels. In such examples, the PPDUs are transmitted over a physical channel having a minimum bandwidth of 20 MHz, although other channel bandwidths are also possible. In some cases, a larger bandwidth channel can be formed using channel bonding, which bonds together multiple channels, each channel of the minimum bandwidth.

Each PPDU is a composite structure that includes a PHY preamble and a payload in the form of a PHY Service Data Unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

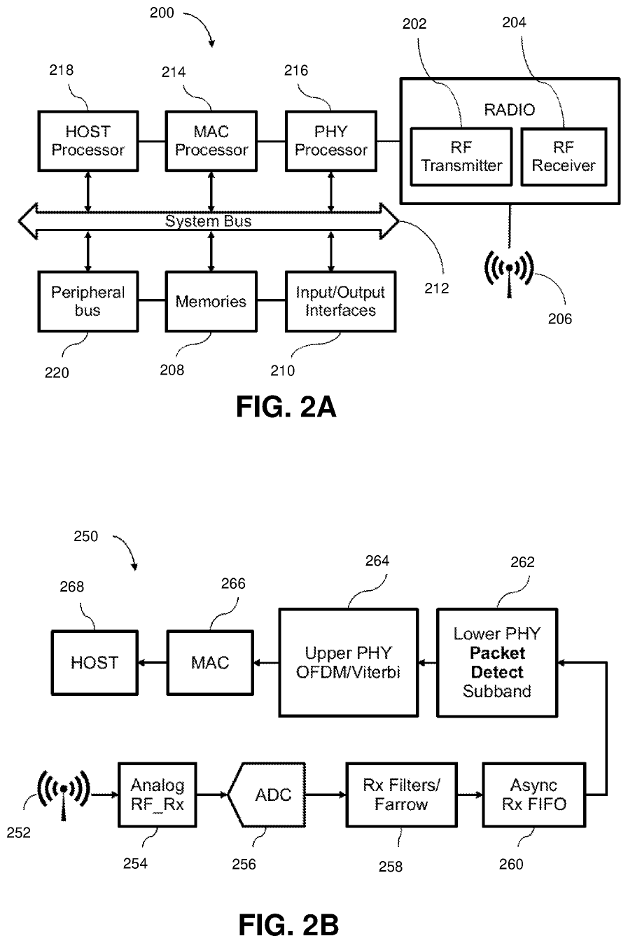

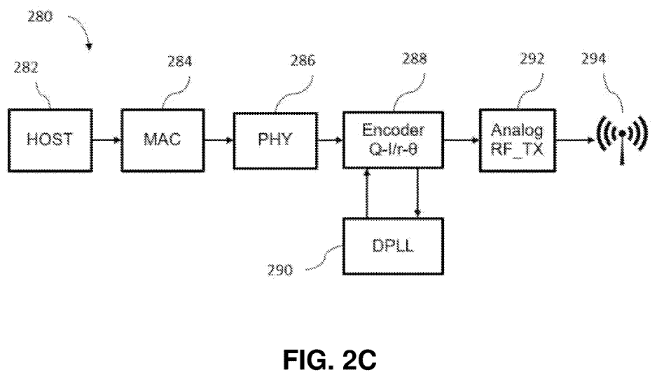

FIG. 2A is a high-level block diagram of an exemplary wireless communication device 200 that can be used to implement a STA or an AP, in some examples. The wireless communication device 200 can include a MAC layer and a PHY layer in accordance with one or more of the IEEE 802.11 standards.

The wireless communication device 200 includes a Radio Frequency (RF) transmitter module 202, an RF receiver module 204, an antenna unit 206, one or more memory banks 208, input and output interfaces 210, and communication bus 212. The RF transmitter module 202 and the RF receiver module 204 include a modem (modulator-demodulator device), which transmits data by modulating one or more carrier wave signals to encode digital information, as well as receives data by demodulating the signal to recreate the original digital information. As illustrated, the wireless communication device 200 further includes a MAC processor 214, a PHY processor 216 and a HOST processor 218. These processors can be any type of Integrated Circuit (IC) including a general processing unit, an Application Specific Integrated Circuit (ASIC) or Reduced Instruction Set Computer-Five (RISC-V) based ICs, amongst others.

The memory 208 can be used to store software and/or computer-readable instructions, including software or instructions that can be used to implement at least some functions of the MAC layer. For example, each processor included in the wireless communication device 200 (e.g., MAC processor 214, PHY processor 216, HOST processor 218, etc.) executes respective software to implement the functions of the respective communication/application layer.

The PHY processor 216 includes a transmitting signal processing unit and a receiving signal processing unit (not shown) and can be used to manage the interface with the Wireless Medium (WM). The PHY processor 216 operates on PPDUs by exchanging digital samples with the radio module which includes the RF transmitter 202, the RF receiver 204, analog-to-digital converters, and digital filters.

The MAC processor 214 executes MAC level instructions and manages the interface between the application software and the WM, through the PHY processor 216. The MAC processor 214 is responsible for coordinating access to the WM so that the Access Point (AP) and STAs in range can communicate effectively. The MAC processor 214 adds header and tail bytes to units of data provided by the higher levels and sends them to the PHY layer for transmission. The reverse happens when receiving data from the PHY layer. If a frame is received in error, the MAC processor 214 manages the retransmission of the frame.

The HOST processor 218 interfaces with the MAC layer and is responsible for running higher level functionalities of the wireless communication device.

The PHY processor 216, the MAC processor 214, the HOST processor 218, the peripheral bus 220, the memories 208, and the input/output interfaces 210 communicate with each other via the peripheral bus 212. The peripheral bus 220 connects to a number of peripherals that support core functions of the wireless communication device 200, including timers, interrupts, radio/filters/system registers, counters, UART, GPIO interfaces, among others. The memory 208 may further store an operating system and applications. In some examples, the memory may store recorded information about captured frames and packets. The input/output interface unit 210 allows for exchange of information with a user of the wireless communication device. The antenna unit 206 can include a single antenna and/or can include or multiple antennas. For example, multiple antennas can be used to implement Multiple Input Multiple Output (MIMO) techniques, among others.

FIG. 2B illustrates a schematic block diagram of a receiver data flow architecture 250 that can be used to receive Wi-Fi packets over the network. In one illustrative example, the receiver data flow architecture 250 illustrated in FIG. 2B can correspond to or otherwise be associated with the wireless communication device 200 illustrated in FIG. 2A. Radio signals are received over the WM and translated into electrical signals by the receiving antenna 252 (e.g., which can be the same as or similar to antenna 206). The received signal is conditioned using a series of analog filters 254 (e.g., depicted as analog RF receive (Rx) filters) before being converted into a digital signal equivalent using an Analog-to-Digital Converter (ADC) 256. The sampled signal output of ADC 256 is conditioned again using a filter bank 258, which can include one or more digital RF filters and/or a farrow, before the samples are collected in an asynchronous receiving First-In-First-Out (FIFO) data structure 260.

Samples in FIFO structure 260 can be accessed by a plurality of modules. For example, samples can be accessed by a packet detect module and a sub-band module, both of which may be included in the lower-level PHY portion 262 depicted in FIG. 2B. In some embodiments, the lower-level PHY portion 262 is itself included in the PHY processor 216 illustrated in FIG. 2A.

The packet detect module included in the lower-level PHY portion 262 can include hardware and/or implement algorithms that can be used to analyze the initial sections of the PPDU in the time domain. Based on the analysis, the packet detect module can be used to recognize a received frame and synchronize frequency and timing of the wireless communication device with the packet being received. The sub-band module included in the lower-level PHY portion 262 can include hardware and/or implement algorithms that can be used to detect which subchannel in the allocated frequency band is being used for the packet being received.

Once a packet is detected and the relevant subchannel is established, samples can be forwarded to an upper-level PHY portion 264. The upper-level PHY portion 264 can be included in the PHY processor 216 illustrated in FIG. 2A. In some aspects, upper-level PHY portion 264 can be used to process and decode Orthogonal Division Multiplexing (OFDM) symbols (e.g., with the support of a coprocessor module) to reconstruct the full PPDU. The reconstructed PPDU is output by the upper-level PHY portion 264 and subsequently processed by the MAC layer processor 266. The MAC layer processor 266 can be used to extract the data payload from the PPDU and provide the relevant information to the HOST layer 268 for consumption.

In some examples, the MAC layer processor 266 illustrated in FIG. 2B can be the same as or similar to the MAC processor 214 illustrated in FIG. 2A. In some cases, the HOST layer 268 illustrated in FIG. 2B can include or otherwise can be the same as or similar to the HOST processor 218 illustrated in FIG. 2A.

FIG. 2C is a schematic block diagram of a transmitter data flow architecture 280 that can be used to transmit RF signals over a wireless medium, in accordance with some examples. More particularly, FIG. 2C illustrates a simplified schematic block diagram of a transmitter data flow architecture 280 used for transmitting radio signals over a WM. Data can be generated from a HOST or APP module 282 and packaged in a MAC level Protocol Data Unit (MPDU) to be routed over the wireless network by the MAC management module 284. The PHY module 286 interfaces with the WM and compiles a PPDU by adding a PHY preamble and the tail to the MPDU. Usually a Modulation Coding Scheme (MCS) for transmission of the packet over the medium is established using a rate control algorithm by the MAC module 284 or the PHY module 286. The modulation scheme selected can define the modulation technique to be used to transmit the data on the WM and the coding rate. Based on the modulation scheme selected, for example Quadrature Amplitude Modulation (QAM) 64, the PPDU is modulated to be transmitted on the WM. The encoder module 288 generates signals corresponding to points of QAM constellation symbols (groups of bits of the PPDU) which can be encoded using polar (r-θ) or cartesian (Q-I) coordinates. The modulation is done by linking the encoder module 288 to a Digital Phase Lock Loop (DPLL) 290. The modulated signals may be filtered by analog filters 292 and transmitted using a transmitting antenna 294.

As noted previously, the systems and techniques described herein can be used to provide improved short frame protection in a wireless communication network, including short frame protection with a reduced overhead and/or short frame protection for various communications associated with Wi-Fi and/or S1G WLANs, including Wi-Fi HaLow networks. For example, aspects of the present invention can be used to provide short frame protection for S1G beacon frames, among various others. As also noted previously, unprotected beacon frames may be vulnerable or susceptible to various security attacks, and IEEE 802.11 beacon packets (e.g., used by the 802.11 MAC or PHY layer in the 2.4, 5, and 6 GHz bands) may implement beacon protection in the form of a Message Integrity Code (MIC) that covers all but the timestamp field of the beacon frame contents. The use of the MIC-based beacon protection can provide protection against tampering of most fields in the beacon frame, but introduces additional signaling overhead based on the requirement that the beacon frame now carry additional bits to represent or indicate the MIC.

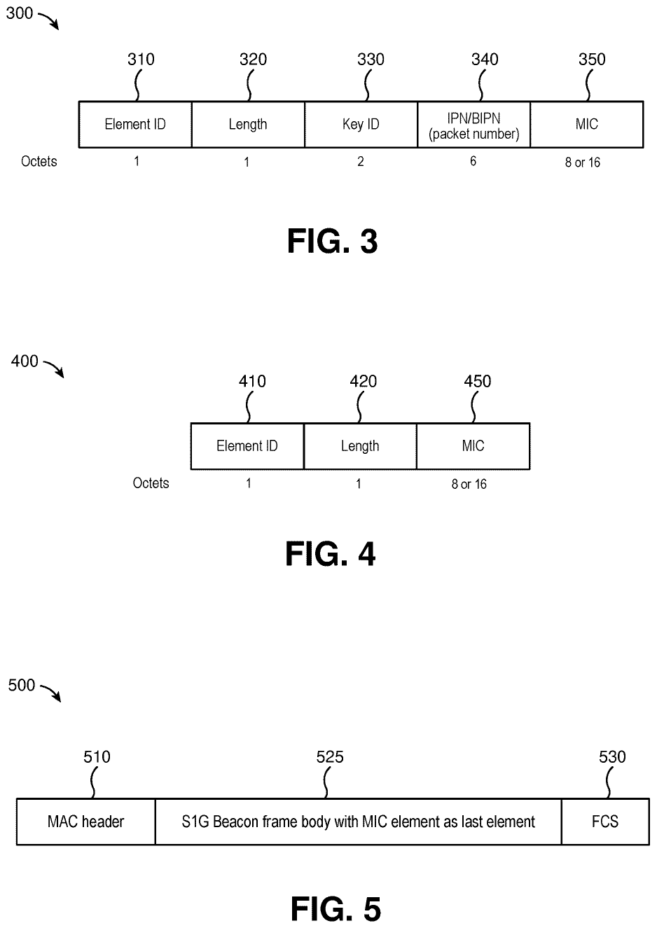

For example, FIG. 3 is a diagram illustrating an example format of a Management MIC Element (MME) 300, which may be used to add a MIC to a beacon frame (e.g., to implement MIC-based beacon protection for the beacon frame). The MME 300 can include one octet (e.g., eight bits) corresponding to an ‘Element ID’ 310; one octet corresponding to a ‘Length’ 320; two octets corresponding to a ‘Key ID’ 330; six octets corresponding to a packet number 340; and eight or 16 octets corresponding to a MIC 350. The packet number 340 can comprise an Integrity Group Temporal Key (IGTK) packet number (IGN) and/or a Beacon Integrity Group Temporal Key (BIGTK) packet number (BIPN). The Key ID 330 can correspond to the current beacon protection session key. The packet number 340 is not permitted to repeat values while the current beacon protection session key is in use. The MIC 350 can be either eight or 16 octets in length, for example based on the authentication algorithm that is used in combination with the MME 300 to implement beacon protection and/or based on whether the beacon protection key (e.g., corresponding to the Key ID 330) is 128 or 256 bits in length.

FIG. 4 is a diagram illustrating an example format of a MIC element 400, which in some cases may be a MIC element for protecting the beacon frame. The MIC element 400 includes an Element field 410 (e.g., ‘Element ID’, comprising one octet), a Length field 420 (comprising one octet), and a MIC field 450 (comprising eight octets or 16 octets). The length of the MIC field 450 is either eight or 16 octets depending on the authentication algorithm, and in some cases, the beacon protection key length being either 128 or 256 bits. In some cases, the MIC field 450 included in the MIC element 400 can be the same as or similar to the MIC field 350 included in the MME 300 of FIG. 3.

The additional overhead associated with implementing beacon frame protection using the MME 300 with MIC 350, or the MIC element 400 with MIC 450, can be more significant in congested networks and networks with relatively limited airtime. For example, as noted previously above, Wi-Fi HaLow and/or other S1G wireless networks may utilize bandwidths that are approximately one order of magnitude narrower than the bandwidths utilized by non-S1G IEEE 802.11 Wi-Fi networks, and symbol durations that can be up to an order of magnitude longer than the symbol durations in non-S1G IEEE 802.11 Wi-Fi networks. As such, Wi-Fi HaLow networks have both significantly narrower bandwidths and significantly longer symbol durations within that narrower bandwidth, as compared to a Wi-Fi 5 or other more recent Wi-Fi network. Accordingly, airtime is more limited as a whole, and the airtime used for each individual data transmission in a HaLow network is also much longer as compared to a Wi-Fi 5 network. Although Wi-Fi HaLow STAs can be grouped to minimize contention on the air media, effective and efficient radio resource management methods for preventing network congestion are still needed for Wi-Fi HaLow networks. For example, it may be beneficial to provide short frame protection, including beacon frame protection, with reduced signaling overhead to consume less airtime in Wi-Fi HaLow networks, S1G networks, and/or various other wireless networks with relatively limited airtime.

Short frame protection can be beneficial in wireless communication systems, based on the use of short frame protection improving the network security level. Short frame protection can often be associated with the tradeoff of increased frame length, corresponding to the length of a security section added to the protected frames. It would be desirable to design a frame protection mechanism for certain short frames or under certain conditions to provide protection while minimizing the additional overhead corresponding to the security section or frame protection bits that are added to the short frame(s).

Various embodiments of the present invention provide a short frame protection method which adds protection with a considerably shorter security section appended to or inserted within the short frame. The short frame protection method can be used to protect various ones of the IEEE 802.11 management frames, control frames, and/or data frames. For example, the systems and techniques described herein can be used to provide frame protection with reduced overhead (e.g., short frame protection) for the management frames used to manage the BSS (e.g., which includes probing, associating, roaming, and disconnecting clients from the BSS, etc.). In one illustrative example, a management frame that is protected by the short frame protection method described herein is a beacon frame. In another example, the short frame protection method described herein can be used to protect the control frames that are used to control access to the medium, for frame acknowledgement, etc. An example of a control frame that may be protected by the short frame protection method described herein is a Null Data Packet (NDP) Carrying Medium Access Control information (CMAC) frames, where the NDP CMAC frames may include NDP Clear to Send (CTS) frames, NDP paging frames, etc.

Various embodiments of the present invention can be used to protect a short frame (e.g., to implement short frame protection) by applying an authentication algorithm to compute an integrity value at a transmitter and a receiver (e.g., a transmitter such as an AP that transmits the short frame, and a receiver such as a STA that receives the short frame). For example, the integrity value used for protecting the short frame can be calculated based on a target transmission time of the short frame. The integrity value can be calculated separately or independently by both the transmitter and by the receiver, based on the target transmission time of a given short frame being known to both the transmitter and the receiver (e.g., causing the transmitter and the receiver to calculate the same integrity values for a given short frame and corresponding target transmission time). For instance, the target transmission time may be a Target Beacon Transmission Time (TBTT) or Target Short Beacon Transmission Time (TSBTT), in examples where the frame being protected is a beacon frame.

More generally, the short frame protection techniques described herein can be implemented using a target transmission time to calculate, derive, generate, etc., an integrity value at the transmitter side and the receiver side, where the target transmission time is either known by both transmitter and receiver or the target transmission time can be estimated or derived by the receiver. For example, the TBTT or TSBTT can be used as the shared reference target transmission time by both the transmitter (e.g., AP) and the receiver (e.g., STA) of a protected short frame, based on the TBTT/TSBTT being a configured periodic time interval known and/or synchronized across the AP and STAs. The TBTT can be a synchronized time between the AP and the STAs, for example based on the STAs having associated with the AP when joining the network and/or performing other time synchronization functions or operations. STAs may maintain TBTT timing information in order to listen for beacons that are transmitted by the AP at the periodic time interval of the TBTT (e.g., which can be measured in Time Units (TUs)). In some cases, one TU can be equal to 1024 microseconds (μs) and/or the TBTT can have a default value of 102.4 ms, although various other values may also be utilized.

The transmitter of the short beacon (e.g., which in some embodiments may be an S1G beacon frame, etc.) can implement protection for the transmitted frame by computing a corresponding integrity value and inserting or appending the computed integrity value (or a corresponding truncated portion thereof) in the short frame. In some aspects, the integrity value can be calculated immediately prior to the transmission of the protected short frame that includes the computed integrity value information. For example, the transmitter (e.g., AP) can obtain a current Time Synchronization Function (TSF) timer value, compute the integrity value using the TSF timer, and immediately generate and transmit the protected short beacon that includes the computed integrity value information. In such cases, the TSF timer value used by the transmitter for calculating the integrity value may be slightly earlier than the actual TBTT/TSBTT at which the protected short beacon is transmitted. Accordingly, in some embodiments the transmitter can take a ceiling of the TSF input (e.g., the TSF timer value noted above) to the integrity calculation, such that the integrity calculation is performed based on Ceil (transmitter TSF input), to thereby obtain a computed integrity value that is rounded up (e.g., by taking the ceiling) to account for the input TSF timer used in the calculation being slightly earlier (e.g., ahead of) the actual TBTT/TSBTT used for transmitting the protected short beacon.

Similarly, the receiver of the protected short frame receives the protected short frame at a time slightly later than the actual TBTT/TSBTT corresponding to the transmission of the protected short frame. The receiver checks and verifies the authentication of the received short frame based on comparing the integrity value carried in the protected short frame, to an expected integrity value that is calculated by the receiver (e.g., using the target transmission time information that is synchronized between the transmitter and the receiver). In some examples, the receiver may calculate the expected integrity value using a current TSF timer value obtained by the receiver in response to receiving a protected short frame carrying an integrity value. In this case, the current TSF timer value used by the receiver as input to the calculation of the expected integrity value is slightly later than the actual TBTT/TSBTT, and the receiver can accordingly take a floor of the TSF input (e.g., TSF timer value) to the integrity calculation, such that the integrity calculation is performed based on Floor (receiver TSF input) to obtain an expected integrity value computation that is rounded down (e.g., by taking the floor) to account for the input TSF timer delay or difference relative to the actual TBTT/TSBTT. In some embodiments, the transmitter may truncate the computed integrity value before inserting or appending the integrity information to the short frame (e.g., to further reduce the total length, and therefore signaling overhead, of the protected short frame). In examples where the receiver receives a protected short frame with truncated integrity information, the receiver can compare the received truncated integrity information with non-truncated expected integrity information calculated by the receiver, or can perform a corresponding truncation to thereby compare the received truncated integrity information with truncated expected integrity information determined by the receiver.

In some embodiments of short frame protection, a MAC Management Protocol Data Unit (MMPDU) transported in a management frame includes a Message Integrity Code (MIC) element (e.g., such as the MIC element 400 of FIG. 4) or a Management MIC Element (MME) (e.g., such as the MME 300 of FIG. 3). The MIC field in a beacon frame can be the same as or similar to the MIC field 350 of the MME 300 of FIG. 3, and/or the MIC field 450 of the MIC element 400 of FIG. 4, and can contain a MIC calculated over the beacon frame based on an authentication algorithm. The MIC can be an example of the integrity value used for the short frame protection described herein. The length of the MIC field may depend on the specific cipher negotiated, and is either 8 octets or 16 octets according to some embodiments of the present invention.

In some examples, the authentication algorithm used for the short frame protection and/or integrity value computation described herein can be based on Broadcast/multicast Integrity Protocol (BIP), which is a protocol configured to provide data integrity and replay protection for group addressed robust Management frames. Some examples of the authentication algorithm that may be used for short frame protection are BIP-CMAC-128, BIP-CMAC-256, BIP-GMAC-128, and BIP-GMAC-256. For S1G STAs, BIP can be used to provide data integrity and replay protection for S1G beacon frames after (e.g., based on or using) establishment of a Beacon Integrity Group Temporal Key Security Association (BIGTKSA). When BIP authentication algorithms are utilized, establishment of a BIGTKSA can be based on a group key handshake (e.g., a BIGTKSA can be the result of a successful group key handshake, successful 4-way handshake, etc.).

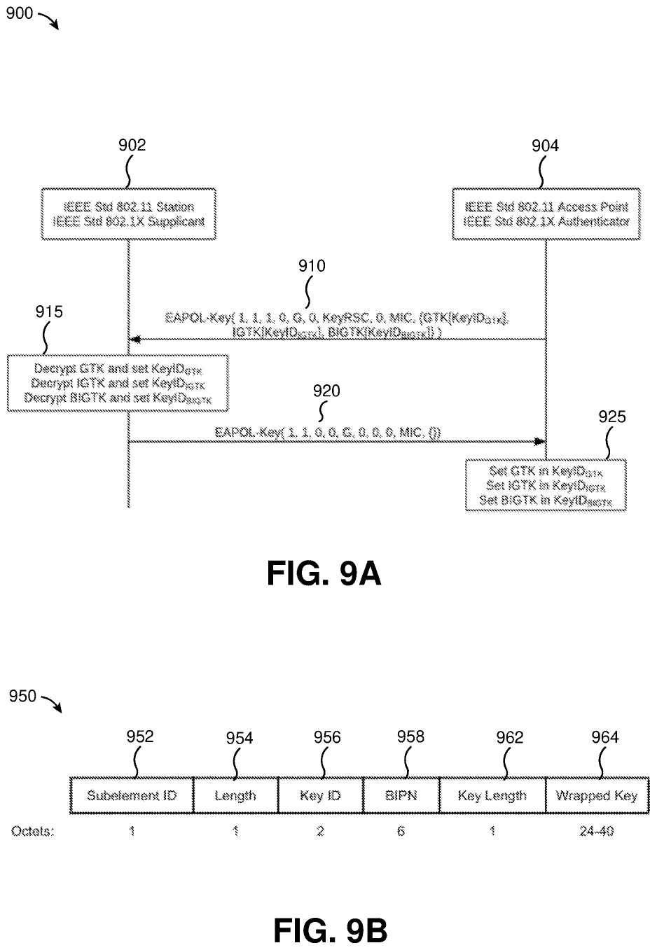

For example, FIG. 9A is a signaling diagram illustrating an example of a group key exchange using a group key handshake process 900. The group key handshake 900 can be performed between a supplicant 902 (e.g., a STA) and an authenticator 904 (e.g., an AP). The authenticator 904 can use the group key handshake 900 to send one or more of a new Group Temporal Key (GTK), Integrity Group Temporal Key (IGTK), and/or Beacon Integrity Group Temporal Key (BIGTK) to the supplicant 902. The authenticator 904 may initiate the group key exchange periodically or when a supplicant (e.g., supplicant/STA 902) has successfully completed the 4-way handshake after association. In some examples, the authenticator 904 may also perform a group key exchange in order to change one of the keys delivered in the group key handshake, for instance using a timer-based trigger to periodically perform the group key exchange to change keys at a given interval (e.g., such as every 120 seconds, etc.). The authenticator 904 may also perform a group key exchange when a STA (e.g., different from or other than the STA 902) disassociates or deauthenticates.

To transmit the first message 910, the authenticator 904 can generate a new BIGTK when beacon protection is enabled. The authenticator 904 can encapsulate the newly generated BIGTK and sends an Extensible Authentication Protocol over LAN (EAPOL)-Key frame containing the BIGTK, along with the last BIPN used with the BIGTK. Further details of the BIPN are described below with reference to FIG. 9B and the BIPN field 958. Returning to the discussion of FIG. 9A, the first message 910 can comprise the EAPOL-Key frame that contains the BIGTK generated by the authenticator 904. For example, the first message 910 can comprise the EAPOL-Key frame given by EAPOL-Key(1, 1, 1, 0, G, 0, Key RSC, 0, MIC, {GTK [Key|D_{GTK}], IGTK [Key|D_{IGTK}], BIGTK [Key|D_{BIGTK}]}). Here, the term BIGTK [Key|D_{BIGTK}] represents the BIGTK with its corresponding key identifier.

Upon receiving the first message 910 (e.g., the EAPOL-Key frame), the supplicant 902 can validate the MIC, decapsulate the BIGTK, and configure the BIGTK and BIPN in its STA. For example, at block 915, the supplicant 902 can decrypt the BIGTK indicated in the first message 910, and can set the KeyID_{BIGTK} for the STA. The supplicant 902 can subsequently construct and send, to the authenticator 904, a second message 920 comprising an EAPOL-Key frame in acknowledgement of the first message 910 from the authenticator 904. For example, the second message 920 can comprise the EAPOL-Key frame given by EAPOL-Key(1, 1, 0, 0, G, 0, 0, 0, MIC, { }).

Upon receiving the EAPOL-Key frame of the second message 920 from the supplicant 902, the authenticator 904 can validate the MIC contained in the second message 920. At block 925, the authenticator 904 can set the BIGTK in KeyID_{BIGTK} for the AP.

As noted above, FIG. 9B is a diagram illustrating an example format of a BIGTK sub-element 950 including a BIPN field 958. In one illustrative example, the BIGTK [Key|D_{BIGTK}] included in the first EAPOL-Key frame 910 transmitted from the authenticator 904 to the supplicant 902 in the group key handshake 900 of FIG. 9A can be the same as the BIGTK sub-element 950 of FIG. 9B. The BIGTK sub-element 950 can include a sub-element ID field 952, carried on one octet; a length field 954, carried on one octet; a Key ID field 956, carried on two octets; a BIPN field 958, carried on six octets; a key length field 962, carried on one octet; and a wrapped key field 964, carried on 24-40 octets. The BIPN field 958 can be used to carry or store a beacon integrity packet number (BIPN).

In some examples, the BIGTK can be identified using the MAC address of the transmitting STA, in combination with a BIGTK key ID that may be encoded in an MME Key ID field (e.g., the same as or similar to the Key ID field 956 of FIG. 9B, and/or the Key ID field 330 of the MME 300 of FIG. 3, etc.). In some examples, the MME can follow all of the other elements in the body of a management frame, other than the frame check sequence (FCS). In other words, the MME can be located before the FCS in the management frame, and after all of the other elements in the body of the management frame (e.g., such as a beacon frame). In some embodiments, the example described above can correspond to a BIP encapsulation format, which may also be referred to as a frame format for a protected management frame using BIP encapsulation.

FIG. 5 is a diagram illustrating an example frame format for an S1G beacon frame using BIP compact encapsulation (BCE) 500, in accordance with some examples. The frame format shown in FIG. 5 may also be referred to as a BIP compact encapsulation format, and in some embodiments can be utilized to protect S1G beacon frames using BCE. In one illustrative example, the BIP compact encapsulation frame format 500 can include a MAC header 510 preceding an S1G beacon frame body 525, and an FCS 530 following the S1G beacon frame body 525. In the BIP compact encapsulation frame format 500, the S1G beacon frame body 525 can be configured to include a MIC element as the element within the S1G beacon frame body 525 (although still before the FCS 530). In some embodiments, the MIC element included as the last element in the S1G beacon frame body 525 may be the same as or similar to the MIC element 400 of FIG. 4.

As noted previously above, a beacon frame generated by an AP for a BSS provides information about the network capabilities and timestamps for synchronization. The beacon frame(s) are transmitted periodically, for example, at a configured TBTT. Beacon protection is desirable, but not available with existing techniques, for beacon frames used by the IEEE 802.11ad/aj (60 GHz and 45 GHz bands) or IEEE 802.11ah (Sub-1 GHz bands) MAC/PHY layers, which are extension frames with a different format than legacy beacon frames. In some examples, the beacon protection as currently specified in the Wi-Fi standard(s) for legacy beacon frames that are used by the 802.11 MAC/PHYs in the 2.4, 5, and 6 GHz bands would add a minimum of 18 bytes to an IEEE 802.11ah beacon frame. In other words, implementing beacon protection for legacy beacon frames increases the length of the protected legacy beacon frames by at least 18 bytes (e.g., adds at least 18 bytes of additional overhead to each beacon frame transmission).

The additional overhead of at least 18 bytes for security (e.g., security information used to protect the beacon frame, implement an integrity check or replay counter, etc.) greatly increases the airtime required for transmitting the IEEE 802.11ah beacon frame. The length of the beacon frames can additionally be seen to affect the network load and receive power requirements for battery powered STAs, which may be undesirable. For example, the probability of the network becoming congested increases when the additional overhead of 18 or more bytes is added to each protected beacon frame transmission. The power consumption of the STA will also increase due to the additional overhead of each protected beacon frame corresponding to an increased airtime for each beacon transmission, and therefore each beacon reception by the STA.

For S1G beacon transmissions, the increased airtime and signaling overhead associated with conventional approaches to beacon protection can become especially critical, such as in some countries with regulatory requirements that a duty cycle constraint be applied in the Sub-1 GHz bands. Accordingly, aspects of the short frame protection described herein can be utilized to provide beacon protection with a reduced number of octets required to protect each beacon frame.

The existing (e.g., legacy) beacon protection mechanism used by the IEEE 802.11 MAC/PHYs for the 2.4, 5, and 6 GHz bands does not cover the timestamp field in the legacy beacon frame. Instead, the timestamp field is set to all zeros when the MIC used for the legacy beacon protection is calculated. It can be difficult to encrypt or protect a timestamp field in the beacon frame, because the value of the timestamp field is continuously changing or updating (e.g., with the progression of time). Unlike other fields within a beacon frame that is to be protected, the value of the timestamp field can change, become incorrect or outdated, etc., including over relatively short intervals such as the time between an AP beginning the beacon protection processing and the later time at which the AP actually transmits the protected beacon frame. In some examples, the challenges in encrypting or protecting the timestamp field of a beacon frame can be based on the timestamp field representing the time that the portion of the packet containing the timestamp is actually transmitted over the air, which is difficult to protect in real time.

As such, protected legacy beacon frames carry an unprotected timestamp field, which can present various vulnerabilities to spoofing and/or other attacks. For example, a protected beacon frame that includes a correct MIC (e.g., such as the MIC 350 of the MME 300 of FIG. 3, the MIC 450 of the MIC element 400 of FIG. 4, etc.) but a spoofed timestamp can be sent by an attacker and may cause problems or other issues for power-save STAs that receive the protected beacon frame with the spoofed timestamp. For instance, a STA receiving such a beacon frame with a correct MIC and a spoofed timestamp may experience a synchronization error. The beacon frame with the spoofed timestamp may additionally cause the STA to disassociate with the AP, based on a spoofed timestamp value that does not match the correct timestamp value. For example, a spoofed timestamp that is earlier than the correct time can cause the STA to disassociate with the AP, as the STA perceives the time has gone backwards implying that the AP has restarted.

In some aspects, embodiments of the presently disclosed short frame beacon protection described herein are based on the periodic nature of beacon frames, and the fact that both the transmitter of a beacon frame (e.g., an AP) and the receivers of a beacon frame (e.g., a STA) know the time when the beacon frame will be sent or should be sent (e.g., a target transmission time of the beacon frame). In particular, beacon frames are scheduled at the Target Beacon Transmission Time (TBTT), which is an absolute time that the AP attempts to send to the STAs which are listening for it. When the STA receives a beacon frame sent from the AP, the beacon frame includes a timestamp or other timing information that is used by the STA to set the Time Synchronization Function (TSF) by changing the local clock of the STA. By setting and/or updating its TSF and local clock based on a timestamp or other timing information indicated by an AP in a beacon frame transmitted to the STA, the STA is able to maintain time synchronization with the AP (and may perform resynchronization and/or confirm synchronization for one or more, or all, of the subsequent beacons received by the STA from the same AP, etc.).

That is, using one or more of the TSF, the TBTT, and/or the timestamp of a received beacon frame, the STA has (e.g., can determine) a relative time between its local clock and a clock of the AP, based on whether or not the beacon frame was delayed relative to the STA's expectation calculated from its own local clock information. The TSF maintained by the STA can be relative while the TBTT is absolute. Because the TBTT is absolute, the TSF at the STA will not drift over time and will not vary more than a maximum delay of a beacon period. A Target Short Beacon Transmission Time (TSBTT) can be used in a same or similar manner, with the TSBTT providing absolute time information corresponding to a short beacon which is shorter than a full beacon frame e.g., the transmission of a short beacon frame with less information than a full, or non-short frame beacon). As used herein, the term “TBTT” can be used to refer to a TBTT, a TSBTT, or both.

In some embodiments of the presently disclosed short frame beacon protection with reduced signaling overhead, the six octet packet number in the MME of a legacy beacon frame is replaced with the TBTT for calculating an integrity value using an authentication algorithm. For example, the legacy beacon frame MME can be the same as the MME 300 of FIG. 3, which includes a six octet packet number in the IPN/BIPN (e.g., packet number) field 340. In some embodiments, the packet number field 340 within the MME 300 can be replaced with the TBTT for calculating an integrity value for beacon protection with reduced signaling overhead.

In some embodiments, the authentication algorithm used for calculating the integrity value based on the TBTT can include one or more of AES-128-CMAC (Cipher-based Message Authentication Code) and AES-128-GMAC (Galois Message Authentication Code). In some aspects of the present invention, embodiments of the integrity value can include a MIC/MIC element (e.g., such as the MIC 350, the MIC element 400, the MIC 450, etc.), and/or can include a message authentication code. Both the AP and STAs maintain their own respective copy of the timestamp timer and are capable of computing the TBTT independently.

In one embodiment, to use the TBTT to derive a beacon protection packet number, the TSF timer value (in microseconds) can be obtained, and divided by the configured beacon interval multiplied by 1,024. The same calculation can be implemented at both the transmitter-side (e.g., by the AP) and at the receiver-side (e.g., by the STA) to calculate an initial value corresponding to the beacon protection packet number as

$$\frac{TSFtimer ( μ s )}{BeaconInterval \cdot 1024} .$$

In this embodiment, the beacon interval is measured in TUs. In another embodiment, when the beacon interval is defined in microseconds, the initial value corresponding to the beacon protection packet number is derived by

$$\frac{TSFtimer ( μ s )}{BeaconInterval} .$$

In some embodiments, the beacon protection packet number can correspond to, represent, or otherwise implement (for the AP and the STA) a counter for beacon intervals. For example, the value of the beacon protection packet number calculated as

$$\frac{TSFtimer ( μ s )}{BeaconInterval \cdot 1024}$$

should increment by approximately a value of one for successive or consecutive beacon frame transmissions or receptions. In some aspects, the AP and/or the STA can perform rounding for the calculated output from the calculation

$$\frac{TSFtimer ( μ s )}{BeaconInterval \cdot 1024} ,$$

the rounded value is then used by the AP and/or the STA as the beacon protection packet number or beacon interval counter value.

In one illustrative example, a transmitter (e.g., such as the AP) may determine the beacon protection packet number/beacon interval counter value as: ceiling

$$( \frac{TSFtimer ( μ s )}{BeaconInterval \cdot 1024} ) .$$

Taking the ceiling can correspond to the AP rounding up the calculated output value. The receiver (e.g., such as the STA) may determine the beacon protection packet number/beacon interval counter value as: floor

$$( \frac{TSFtimer ( μ s )}{BeaconInterval \cdot 1024} ) .$$

Taking the floor can correspond to the STA rounding down the calculated output value. The transmitter determines the beacon protection packet number/beacon interval counter value as: ceiling

$$( \frac{TSFtimer ( μ s )}{BeaconInterval} )$$

when the BeaconInterval is in microseconds, and similarly, the receiver determines the beacon protection packet number/beacon interval counter value as: floor

$$( \frac{TSFtimer ( μ s )}{BeaconInterval} ) .$$

In some aspects, the AP divides a timer value by a beacon interval and takes a ceiling to generate a counter, and computes the transmitter-side integrity value using the ceiling-based counter. The receiver of the short frame receives the short frame, and verifies the short frame by comparing the computed integrity value determined by the receiver (e.g., expected integrity value) and the integrity value included in the short frame (e.g., actual or received integrity value). In some aspects, the receiver of the short frame divides a timer value by a beacon interval and takes a floor to generate a counter, and computes the receiver-side integrity value using the floor-based counter. The respective floor and ceiling calculations performed by the STA and the AP (respectively) can implement rounding that corresponds to the relative difference between the TSF timer value and the TBTT.

For example, the AP may calculate the beacon protection packet number/beacon interval counter value immediately prior to the transmission of the beacon frame, based on the AP obtaining a current TSF timer value prior to the TBTT. In such cases, the TSF timer value used by the AP may be slightly earlier than the actual TBTT at which the protected beacon is transmitted. Accordingly, in some embodiments the AP is configured to take a ceiling of the beacon protection packet number/beacon interval counter value calculation, to thereby round up (e.g., by taking the ceiling) to account for the input TSF timer used in the calculation being slightly earlier (e.g., ahead of) the actual TBTT used for transmitting the protected short beacon.

Similarly, the receiver of the protected short frame (e.g., STA) receives the protected short frame at a time slightly later than the actual TBTT corresponding to the transmission of the protected short frame (e.g., based on the airtime of the beacon, reception/decoding time at the STA, etc.). The STA checks and verifies the authentication of the received short frame based on comparing the integrity value carried in the protected short frame, to an expected integrity value that is calculated by the receiver (e.g., using the target transmission time information that is synchronized between the transmitter and the receiver). In some examples, the receiver may calculate the expected integrity value using a current TSF timer value obtained by the receiver in response to receiving a protected short frame carrying an integrity value. In this case, the current TSF timer value used by the receiver as input to the calculation of the expected beacon protection packet number/beacon interval counter value is slightly later than the actual TBTT, and the receiver can accordingly take a floor of the calculation of the expected beacon protection packet number/beacon interval counter value to thereby round down (e.g., by taking the floor) to account for the input TSF timer delay or difference relative to the actual TBTT. In some embodiments, the transmitter may truncate the computed integrity value before inserting or appending the integrity information to the short frame (e.g., to further reduce the total length, and therefore signaling overhead, of the protected short frame). In examples where the receiver receives a protected short frame with truncated integrity information, the receiver can compare the received truncated integrity information with non-truncated expected integrity information calculated by the receiver, or can perform a corresponding truncation to thereby compare the received truncated integrity information with truncated expected integrity information determined by the receiver.

The result of taking the ceiling (e.g., by the AP, on a per-packet basis) or the floor (e.g., by the STA, and/or to calculate the initial/starting value for a series of beacon frames when detecting a replay attack, etc.) is a counter for beacon intervals that can be used to provide the short frame protection with reduced signaling overhead. For example, signaling overhead can be reduced based on replacing the IPN/BIPN or other packet number field 340 within the MME 300, with the TBTT for calculating an integrity value as described above.

Signaling overhead can additionally be reduced based on performing truncation of the beacon protection packet number/beacon interval counter value that is initially calculated by the AP as ceiling

$$( \frac{TSFtimer ( μ s )}{BeaconInterval \cdot 1024} ) .$$

In some embodiments, the truncation of the beacon protection packet number/beacon interval counter value may require rolling over earlier and/or may be implemented based on rolling over earlier. For example, if the calculated beacon protection packet number/beacon interval counter value cannot be carried using the six octets or less of the packet number field 340 within the MME 300, the AP can truncate to six octets if necessary (e.g., by removing the high order bytes and rekeying before the lower six octets roll over), and the authentication algorithm computes an integrity value based on this six-octet counter for beacon intervals. In one embodiment, the AP sends the value of the TSF timestamp at the point of time that the symbol with the first part of the timestamp hits the medium. In some aspects, including the value of the TSF timestamp (or a TSF-based or TSF-derived counter value) within the MME may be used to provide protection for the TSF for 2.4/5/6 GHz BIP (e.g., may be used to provide protection for the beacon timestamp for regular or non-S1G beacons in 2.4/5/6 GHz networks, etc.). In some examples, the calculated beacon counter can be implemented to be backwards-compatible with legacy STAs, for example with the backwards compatibility implemented based on legacy STAs treating the calculated beacon counter value the same as the current BIPN defined for the legacy STAs.

In some examples, the AP can be configured to modify the MME format 300 shown in FIG. 3 to remove the IPN/BIPN packet number 340, which saves six octets for each beacon transmission with an MME. In some cases, the AP can be configured to further modify the MME format 300 to remove the Key ID field 330, which saves an additional two octets for each beacon transmission with an MME. Advantageously, not sending a packet number with the MIC and Key ID saves eight octets per beacon transmission. In some aspects, the MME format 300 can be modified to remove the six octets of the packet number field 340 because the disclosed short frame protection method utilizes the TBTT to indicate or derive packet number information in the form of the calculated beacon protection packet number/beacon interval counter value

$$( \frac{TSFtimer ( μ s )}{BeaconInterval \cdot 1024} ) .$$

The TBTT is a target time but the actual beacon frame will always be sent at or after this target time, depending on how busy the Radio Frequency (RF) medium is. Using the TBTT as the packet number affords some level of protection to the timestamp field, since the receiver of the beacon (e.g., STA) can authenticate or verify that the received value in the timestamp field of a beacon is within a configured range of the TBTT. For example, the STA can authenticate or verify the received timestamp field (thereby providing some level of protection to the timestamp field), because the STA knows that a legitimate (e.g., non-spoofed) value for the timestamp must be the TBTT plus a reasonable time offset. In some embodiments, due to the medium being busy, a sanity check can be performed to ensure the timestamp is in a range between 0 to n from the TBTT, where n is set to be a reasonable period of time from the TBTT for the AP to transmit the beacon frame. For example, n can be set to half a beacon period, and the STA can check or verify that the timestamp of a received beacon is between [TBTT−½ beacon period, TBTT+½ beacon period]. Accordingly, the timestamp field carried by the protected beacon frame cannot be spoofed outside of a limited range, and cannot go backwards.

In an embodiment of using the TBTT to calculate a MIC for beacon protection, the MIC element for protecting the legacy beacon frame may be used. For example, the MIC element 400 of FIG. 4 can be utilized. The currently existing MIC element 400 frame format contains only Element, Length, and MIC fields (e.g., 410, 420, and 450, respectively). The length of the MIC field 450 is eight octets or 16 octets, depending on the authentication algorithm and in some cases depending on the beacon protection key length being either 128 or 256 bits. For example, MIC information for Broadcast/multicast Integrity Protocol (BIP) can be truncated based at least in part on the type and/or configuration of the BIP processing that is performed. In one illustrative example, BIP processing may use AES with a 128-bit or 256-bit integrity key, and a CMAC TLen value of 128 (e.g., 16 octets). The CMAC output for BIP-CMAC-256 is not truncated and can be 128 bits (16 octets). The CMAC output for BIP-CMAC-128 is truncated to 64 bits (e.g., MIC=Truncate-64(CMAC Output)). In another illustrative example, BIP-GMAC-128 uses AES with a 128-bit integrity key and BIP-GMAC-256 uses AES with a 256-bit integrity key. The authentication tag for both BIP-GMAC-128 and BIP-GMAC-256 is not truncated and is 128 bits (16 octets).

In some embodiments of beacon protection, the Key ID of the existing MME format (e.g., the Key ID 330 shown in the MME format 300 of FIG. 3) can be provided separately from the MME used for the short frame protection described herein. For example, the Key ID of the MME can be provided, signaled, indicated, etc., using a currently unused bit in the S1G Beacon Compatibility element. The additional minimum packet overhead required for beacon protection using a MIC element (e.g., MIC element 400) and the calculated beacon protection packet number/beacon interval counter value

$$( \frac{TSFtimer ( μ s )}{BeaconInterval \cdot 1024} )$$

of the disclosed short frame protection method is 10 octets, which is less than the traditional 18 octets of MME overhead used for the legacy beacon protection approaches.

Embodiments of beacon protection using a target beacon transmission time in integrity check or authentication verification provide some level of protection. An advantage of the embodiments of beacon protection described herein, viewed in comparison to the existing beacon protection mechanism, is that the signaling overheads added to the beacon frames as the security/protection information are less. For a 135 byte beacon frame sent at the 2 MHz MCSO (Modulation Code Scheme 0) transmission rate of 650 kbps, appending a 10 octet MIC adds only approximately 3.5% to the current consumption for receiving the beacon frame, whereas the current consumption is about 6.4% for appending an 18 octet MME to the beacon frame.

In one illustrative example, when the disclosed short frame beacon protection is enabled at the STA, the receiver can maintain a 48-bit replay counter for each BIGTK. The replay counter can be set to the value of the BIPN in the BIGTK key data encapsulation (KDE) provided by the Authenticator in a 4-way handshake, FT 4-way handshake, FT handshake, group key handshake, or FILS authentication (e.g., such as a group key handshake between supplicant 902 and authenticator 904 according to the example group key handshake signaling diagram 900 of FIG. 9A, etc.). The transmitter can maintain a single BIPN for each BIGTK.

In some embodiments, when beacon protection is enabled at an S1G AP and BCE is enabled, the BIPN shall be implemented as a 48-bit representation of the number of TSBTTs or TBTTs since TSF time 0. In some examples, when a short beacon interval is utilized, the BIPN can be initialized as BIPN=Floor (TSF/(1024×dot11ShortBeaconPeriod)). In another example, when a short beacon interval is not utilized, the BIPN can be initialized as BIPN=Floor (TSF/(1024×dot11BeaconPeriod)). In some examples, when beacon protection is enabled at an S1G AP and BCE is disabled, the BIPN can be implemented as a 48-bit strictly increasing integer, initialized to 1 when the corresponding BIGTK is initialized. For non-S1G STAs, the BIPN can be implemented as a 48-bit strictly increasing integer, initialized to 1 when the corresponding BIGTK is initialized.

In some examples, various other short frames transmitted on a wireless medium (e.g., in addition to beacon frames, as described above) may also be transmitted without being encrypted or protected, again based on the consideration that adding security to protect a frame incurs considerable additional overhead to the protected frame. For example, short frame protection may be implemented using an encryption protocol called Counter Mode with Cipher Block Chaining Message Authentication Code Protocol, or CCM Protocol (CCMP), which is designed for WLAN networks. CCMP is an enhanced data cryptographic encapsulation mechanism designed for data confidentiality and based upon the Counter Mode with CBC-MAC (CCM mode) of the Advanced Encryption Standard (AES) standard. CCM protects the integrity of the Medium Access Control Protocol Data Unit (MPDU) data field and a selected portion of the MPDU header. AES-CCMP-128 uses a 128-bit key and a 128-bit block size for frame protection. For example, the AES-CCMP-128 header and MIC add 16 octets to an IEEE 802.11 MAC layer frame.

The first section of a CCMP MPDU is a MAC header, which contains the destination and source address of the data packet. The second section of the CCMP MPDU is the CCMP header, which is carried on eight octets and includes the Packet Number (PN), the Ext IV, and the key ID. The PN is a 48-bit number stored across six octets (e.g., six of the eight octets of the CCMP header are used to store the PN). The PN codes are the first two and last four octets of the CCMP header and are incremented for each subsequent packet. CCMP uses these values to encrypt the data unit and the MIC. The third section of the CCMP MPDU is the data unit, which is the data being sent in the packet (e.g., the data payload of the packet). The fourth section of the CCMP MPDU is the MIC, which protects the integrity and authenticity of the packet. Finally, the fifth section of the CCMP MPDU is the Frame Check Sequence (FCS), which is used for error detection.

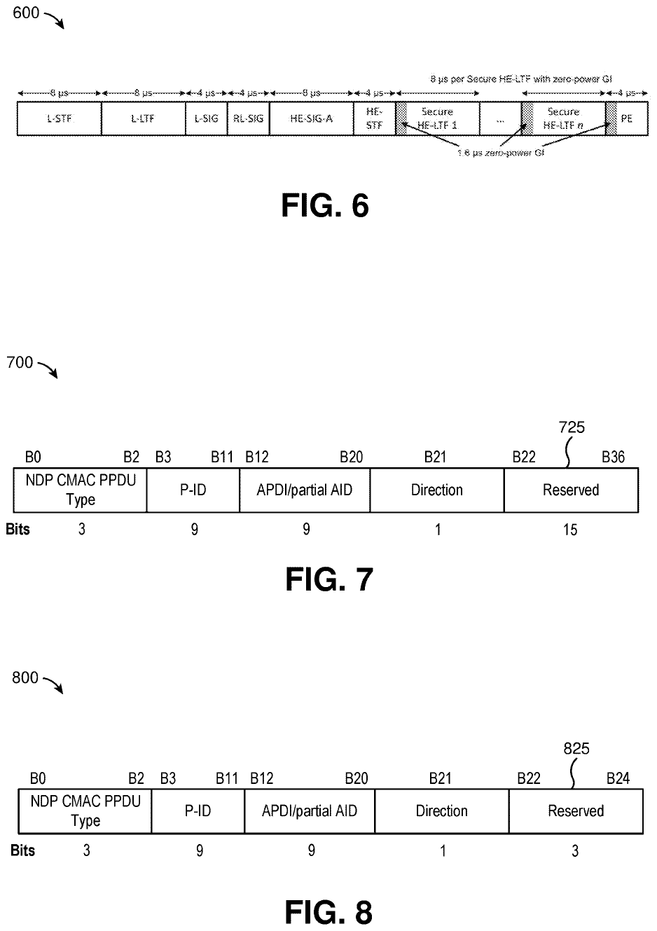

Out of these five sections, only the data unit and MIC of the CCMP MPDU are encrypted. It is worth considering how to efficiently provide security to short frames, such as the Null Data Packet (NDP), which have no data field in which to include a security header and MIC. Protecting short frames against tampering or spoofing is very useful for the network as the STAs can trust the information carried in these short frames. An existing mechanism of providing security to a short frame is in the IEEE 802.11az-2022 standard for Next Generation Positioning, which includes a secure Long Training Field (LTF) in a High Efficiency (HE) Ranging NDP frame. The secure LTF is a randomized LTF sequence constructed using pseudorandom 64-Quadrature Amplitude Modulation (QAM) modulation. An example packet format is shown in FIG. 6, where the secure LTFs have a zero power guard interval. For example, FIG. 6 is a diagram illustrating an example packet format for an HE Ranging NDP frame 600 with secure HE-LTFs (e.g., Secure HE-LTF 1, . . . , Secure HE-LTF n), in accordance with some examples.

In some embodiments of short frame protection, a target transmission time is used with an authentication algorithm such as AES-128-CMAC or AES-128-GMAC to protect short frames that are sent (e.g., transmitted) at a time that can be synchronized with the TSF timer. For example, the short frame that is protected may be a Null Data Packet (NDP) frame sent by an AP and used to notify STAs that there is no buffered traffic. This NDP frame, used for signaling that the AP has no buffered traffic, may also be referred to as a Delivery Traffic Indication Map (DTIM) indication NDP frame. A STA receiving a DTIM indication NDP frame determines that it (e.g., the STA) is not required to receive the entire beacon frame, which is typically used to provide the indication of whether there is buffered data traffic at the AP. In some examples, the DTIM indication NDP frame can be transmitted before the beacon frame, to thereby allow the STA(s) receiving the DTIM indication NDP frame to enter a power-save mode earlier (e.g., the STA can enter the power-save mode based on receiving the DTIM indication NDP frame prior to the beacon frame, rather than the STA entering the power-save mode at the later time after the entire beacon frame is received). Accordingly, the STA reduces its power consumption by receiving a relatively shorter NDP frame rather than receiving the entire beacon frame. Some examples of the DTIM indication NDP frame can include NDP Clear To Send (CTS) frames and/or NDP Paging frames.

In some embodiments, protection can be provided for an NDP frame (e.g., such as a DTIM indication NDP frame, etc.) based on using the TBTT as the target transmission time for the short frame protection method(s) described herein. For example, the TBTT can be used as the target transmission time, known to both the transmitter and the receiver, for computing an integrity value for protecting the DTIM indication NDP frame because it is always sent immediately prior to a beacon. In some embodiments, a computed integrity value (e.g., for example, 128 bits produced by an authentication algorithm such as AES-128-CMAC, etc.) may be truncated to fit into a quantity of available reserved bits of the short frame that is being protected. For example, truncation can be utilized when the length of the computed integrity value (e.g., in bits) is greater than the number of available reserved bits of the short frame being protected.

In some embodiments, if there are insufficient reserved bits in the short frame (e.g., if the length of the computed integrity value is greater than the number of available reserved bits in the short frame), a first portion of the computed integrity value can be indicated using the available reserved bits included in the short frame, and a second (e.g., remaining) portion of the computed integrity value may be appended to the short frame as extra symbols of the computed integrity value. In some aspects, for other short frames that are synchronized to the TSF timer, a target transmission time can be obtained or determined based on the TSF, and can be used as the packet number of the authentication algorithm to compute an integrity value.

In one illustrative example, the short frame protection described herein can be used for protecting an IEEE 802.11ah 2 MHz NDP Paging frame. For example, FIG. 7 is a diagram illustrating an example format of a 2 MHz NDP Paging frame 700. An NDP CMAC PPDU Type can be indicated on three bits, from B0-B2. A P-ID can be indicated on nine bits, from B3-B11. An APDI/partial AID can be indicated on nine bits, from B12-B20. A direction can be indicated on one bit, B21. The remaining 15 bits, from B22-B36, can be reserved bits 725 of the 2 MHz NDP Paging frame 700. In some examples, to implement the short frame protection method, a first reserved bit included in the reserved bits 725 can be used to indicate that the 2 MHz NDP Paging frame 700 is protected. For example, the reserved bit 22 (B22) can be set to a value of ‘1’ to indicate the frame 700 is protected, and the next 12 bits of the set of reserved bits 725 (e.g., B23-B34) can be set to a truncated integrity value, leaving the last two bits of the set of reserved bits 725 (e.g., B35-B36) as still available reserved bits.

In another embodiment, the short frame protection described herein can be used for protecting an IEEE 802.11ah 1 MHz NDP Paging frame. For example, FIG. 8 is a diagram illustrating an example format of 1 MHz NDP Paging frame 800. In some cases, the 1 MHz NDP Paging frame 800 can be the same as the 2 MHz Paging frame 700 of FIG. 7, with the 1 MHz NDP Paging frame 800 including a set of three reserved bits 825 rather than the set of 15 reserved bits 725 included in the 2 MHz NDP Paging frame 700. In some embodiments, the 1 MHz NDP Paging frame 800 as shown in FIG. 8 can be protected by inserting a truncated integrity value. In this embodiment, bit 22 of the set of reserved bits 825 in the 1 MHz NDP Paging frame 800 is set to a value of ‘1’ to indicate that the frame is extended to contain 12 bits of the truncated integrity value. The remaining bits B23 and B24 of the set of reserved bits 825 in the 1 MHz NDP Paging frame 800 can remain as still available reserved bits.

In some cases, the use of truncated integrity values may make it easier for an attacker to spoof a protected frame. However, because since the integrity value (e.g., corresponding to the truncated integrity value) is computed from the authentication algorithm using a packet number replaced by a target transmission time, the attacker has a limited window of opportunity in which to perform spoofing. For example, if a computed integrity value is truncated to 12 bits, the attacker has only a 1 in 4,096 chance (e.g., 2¹²=4,096) of guessing a correct integrity value to associate with a particular packet number at a specific (i.e., absolute) transmission time. In the case of a target transmission time, there will be a window in which a number of attempts can be made. Limiting the window to 10 ms would allow up to approximately 42 attempts to spoof a protected 2 MHz NDP, assuming 240 μs for the NDP frame and no interframe space, which corresponds to an approximately 1% chance of spoofing a protected NDP frame successfully. The 1% probability of successful spoofing can be an acceptable (e.g., acceptably low) risk for protecting an NDP frame designed to wake a sleep STA or allow a sleep STA to remain in a low power mode, where best effort protection is preferable to no protection (and where the STA will wake periodically to receive a full beacon frame to maintain synchronization in any case). In addition, an attacker using multiple spoofed NDP frames is likely to be detectable.

In some embodiments of the short frame protection described herein, the granularity of the target transmission time used for computing the integrity value can be increased by dividing the TSF timer into a plurality of smaller time windows. For example, the TSF timer can be divided into 1,024 μs time windows so that the target transmission time for computing the integrity value is finer grained. The increased granularity provided by dividing the TSF timer can be useful when multiple short frames (e.g. NDP frames) are sent in between beacon frames. For example, an AP may send DTIM indication NDP frames for paging different STAs in different windows of time between the beacon frames, and the target transmission time used to compute the integrity value for each DTIM indication NDP frame has to be unique.

In an embodiment of implementing both beacon protection and DTIM indication NDP protection, a separate key for NDP protection may be needed. Theoretically, the same temporal key cannot be used twice with the same target transmission time (e.g., TBTT) for computing an integrity value using the authentication algorithm. In some embodiments, an AP can be configured to assign a separate key for DTIM indication NDP protection that is different from the key used for beacon protection, and both DTIM indication NDP transmitted prior to a beacon frame as well as the beacon frame can be protected by computing respective integrity values using the same TBTT and the separate keys.

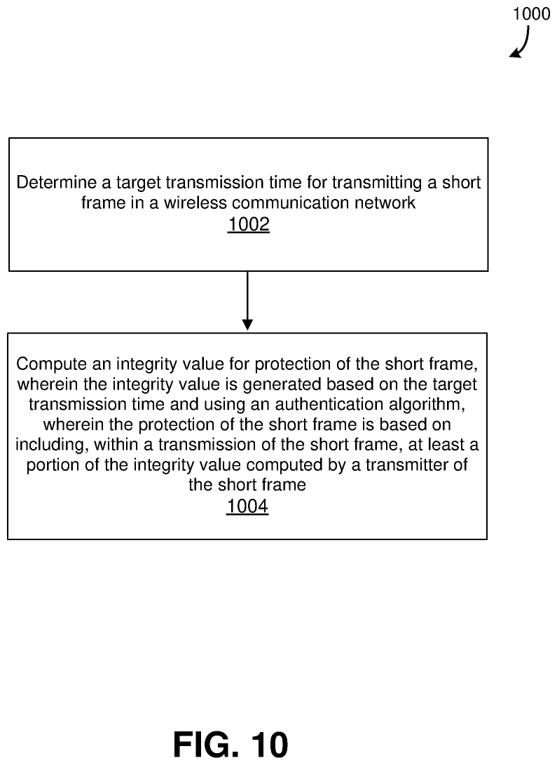

FIG. 10 is a flow diagram of an example of a process 1000 for short frame protection for a short frame transmitted in a wireless communication network. For example, the process 1000 can correspond to short frame protection for a short frame transmitted between an AP and a STA in a wireless communication network, including a Wi-Fi HaLow and/or various other types of S1G networks, etc. In some examples, the process 1000 for short frame protection can be implemented by both the AP and the STA associated with transmitting and receiving, respectively, a short frame. In some cases, the short frame can be a beacon frame, and/or a short beacon frame, including S1G beacon frames, S1G short beacon frames, etc., among various other short frames such as management frames, control frames, and/or data frames transmitted in the wireless communication network.

At block 1002, the process 1000 includes determining a target transmission time for transmitting the short frame. For example, in some cases the short frame is a beacon frame and the target transmission time is a Target Beacon Transmission Time (TBTT) associated with transmitting the beacon frame, or a Target Short Beacon Transmission Time (TSBTT) associated with transmitting the beacon frame.

At block 1004, the process 1000 includes computing an integrity value for protection of the short frame, wherein the integrity value is generated based on the target transmission time and using an authentication algorithm, wherein the protection of the short frame is based on including, within a transmission of the short frame, at least a portion of the integrity value computed by a transmitter of the short frame. For example, in some cases the integrity value is a Message Integrity Code (MIC) or a message authentication code. In some examples, the authentication algorithm is based on a Broadcast/multicast Integrity Protocol (BIP) for protecting an integrity for group addressed frames. The target transmission time for transmitting the short frame can be independently determined by a transmitter and a receiver of the short frame. In some cases, computing the integrity value comprises dividing a timer value by a beacon interval corresponding to the short frame, to thereby obtain a first calculated value, determining a counter based on taking a ceiling of the first calculated value, and computing the integrity value based on the counter.

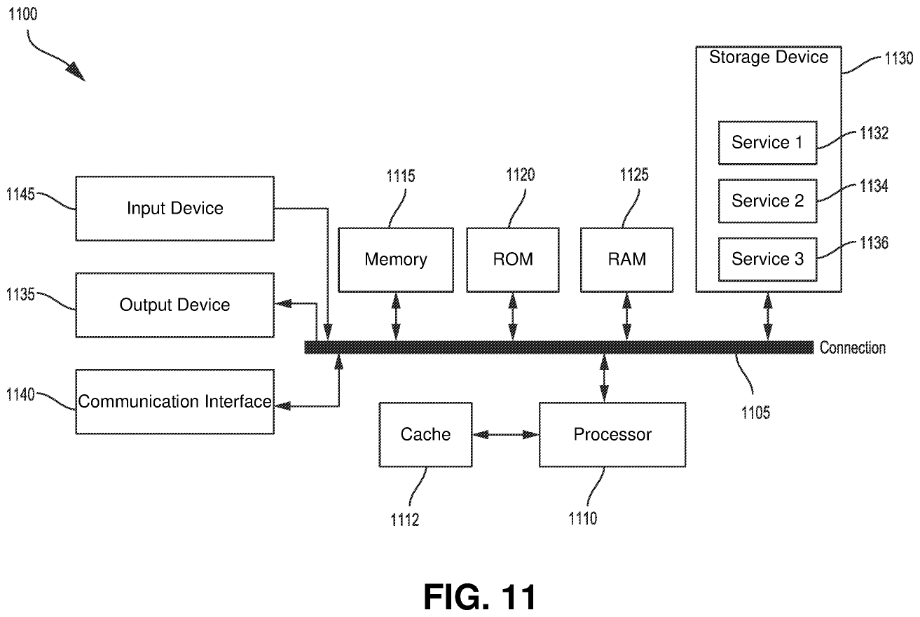

FIG. 11 illustrates a computing device architecture 1100 of a computing device which can implement one or more techniques described herein. In some examples, the computing device can include a mobile device, a wearable device, an extended reality device (e.g., a Virtual Reality (VR) device, an Augmented Reality (AR) device, or a Mixed Reality (MR) device), a personal computer, a laptop computer, a video server, a vehicle (or computing device of a vehicle), or other device. The components of computing device architecture 1100 are shown in electrical communication with each other using connection 1105, such as a bus. The computing device architecture 1100 includes a processing unit 1110 and computing device connection 1105 that couples various computing device components including computing device memory 1115, such as Read Only Memory (ROM) 1120 and Random-Access Memory (RAM) 1125, to processor 1110.

Computing device architecture 1100 can include a cache of high-speed memory connected directly with, in close proximity to, or integrated as part of processor 1110. Computing device architecture 1100 can copy data from memory 1115 and/or the storage device 1130 to cache 1112 for quick access by processor 1110. In this way, the cache can provide a performance boost that avoids processor 1110 delays while waiting for data. These and other engines can control or be configured to control processor 1110 to perform various actions. Other computing device memory 1115 may be available for use as well. Memory 1115 can include multiple different types of memory with different performance characteristics. Processor 1110 can include any general-purpose processor and a hardware or software service, such as service 1 1132, service 2 1134, and service 3 1136 stored in storage device 1130, configured to control processor 1110 as well as a special-purpose processor where software instructions are incorporated into the processor design. Processor 1110 may be a self-contained system, containing multiple cores or processors, a bus, memory controller, cache, etc. A multi-core processor may be symmetric or asymmetric.

To enable user interaction with the computing device architecture 1100, input device 1145 can represent any number of input mechanisms, such as a microphone for speech, a touch-sensitive screen for gesture or graphical input, keyboard, mouse, motion input, speech and so forth. Output device 1135 can also be one or more of a number of output mechanisms known to those of skill in the art, such as a display, projector, television, speaker device, etc. In some instances, multimodal computing devices can enable a user to provide multiple types of input to communicate with computing device architecture 1100. Communication interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, RAM, ROM, and hybrids thereof. Storage device 1130 can include services 1132, 1134, 1136 for controlling processor 1110. Other hardware or software modules or engines are contemplated. Storage device 1130 can be connected to the computing device connection 1105. In one aspect, a hardware module that performs a particular function can include the software or processor readable codes stored in a computer-readable medium in connection with the necessary hardware components, such as processor 1110, connection 1105, output device 1135, and so forth, to carry out the function.

The term “device” is not limited to one or a specific number of physical objects (such as one smartphone, one controller, one processing system and so on). As used herein, a device may be any electronic device with one or more parts that may implement at least some portions of this disclosure.

Individual aspects may be described above as a process or method which is depicted as a flowchart or a data flow diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, or a subprogram. When a process corresponds to a function, its termination can correspond to a return of the function to the calling function or the main function.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above.

The program code may be executed by a processor, which may include one or more processors, such as one or more Digital Signal Processors (DSPs), general purpose microprocessors, an Application Specific Integrated Circuits (ASICs), Field Programmable Gate Arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices.

What is claimed is:

1. A short frame protection method for a short frame transmitted in a wireless communication network, the method comprising:
determining a target transmission time for transmitting the short frame; and
computing an integrity value for protection of the short frame, wherein the integrity value is generated based on the target transmission time and using an authentication algorithm, wherein the protection of the short frame is based on including, within a transmission of the short frame, at least a portion of the integrity value computed by a transmitter of the short frame.

2. The short frame protection method of claim 1, wherein the short frame is a management frame, a control frame, or a data frame transmitted in the wireless communication network.

3. The short frame protection method of claim 1, wherein:
the short frame is a beacon frame; and
the target transmission time is a Target Beacon Transmission Time (TBTT) associated with transmitting the beacon frame, or a Target Short Beacon Transmission Time (TSBTT) associated with transmitting the beacon frame.

4. The short frame protection method of claim 1, further comprising:
generating a protected short frame based on inserting the computed integrity value within the short frame, or appending the computed integrity value to the short frame; and
transmitting the protected short frame to one or more stations in the wireless communication network.

5. The short frame protection method of claim 4, further comprising truncating the computed integrity value to thereby obtain a truncated integrity value for inserting within or appending to the short frame, wherein the protected short frame transmitted on the wireless communication network is protected based on the truncated integrity value.

6. The short frame protection method of claim 4, wherein computing the integrity value comprises:
dividing a timer value by a beacon interval corresponding to the short frame, to thereby obtain a first calculated value;
determining a counter based on taking a ceiling of the first calculated value; and
computing the integrity value based on the counter.

7. The short frame protection method of claim 1, wherein the integrity value is a Message Integrity Code (MIC) or a message authentication code.

8. The short frame protection method of claim 1, wherein the authentication algorithm is based on a Broadcast/multicast Integrity Protocol (BIP) for protecting an integrity for group addressed frames.

9. The short frame protection method of claim 1, wherein the target transmission time for transmitting the short frame is independently determined by a transmitter and a receiver of the short frame.

10. A wireless communication device in a wireless communication network, the wireless communication device comprising:
a Radio Frequency (RF) receiver and a RF transmitter;
a processor, communicatively coupled to the RF receiver and the RF transmitter; and
one or more memory banks, communicatively coupled to the processor and storing processor readable codes that, when executed by the processor, is configured for:
determining a target transmission time for transmitting a short frame; and
computing an integrity value for protection of the short frame, wherein the integrity value is generated based on the target transmission time and using an authentication algorithm, wherein the protection of the short frame is based on including, within a transmission of the short frame, at least a portion of the integrity value computed by a transmitter of the short frame.

11. The wireless communication device of claim 10, wherein the wireless communication device is an Access Point (AP), and wherein:
the processor is configured to generate a protected short frame based on inserting the computed integrity value within the short frame or appending the computed integrity value to the short frame; and
the RF transmitter is configured to transmit the protected short frame in the wireless communication network.

12. The wireless communication device of claim 10, wherein:
the short frame is a beacon frame; and
the target transmission time is a Target Beacon Transmission Time (TBTT) associated with transmitting the beacon frame, or a Target Short Beacon Transmission Time (TSBTT) associated with transmitting the beacon frame.

13. The wireless communication device of claim 10, wherein the integrity value is a Message Integrity Code (MIC) or a message authentication code.

14. A short frame protection method in a wireless communication network, the method comprising:
receiving, by a first network device, a short frame transmitted by a second network device, wherein the received short frame includes information indicative of an integrity value calculated by the second network device based on a target transmission time associated with the short frame;
determining, by the first network device, a target transmission time associated with the received short frame;
computing, by the first network device, an expected integrity value for the received short frame, wherein the expected integrity value is based on the target transmission time determined by the first network device; and
verifying, by the first network device, the received short frame, based on comparing the expected integrity value and the integrity value indicated in the received short frame.

15. The short frame protection method of claim 14, wherein the first network device comprises a station (STA) included in the wireless communication network, and wherein the second network device comprises an Access Point (AP) included in the wireless communication network.

16. The short frame protection method of claim 14, wherein:
the received short frame is a protected beacon frame; and
the target transmission time is a Target Beacon Transmission Time (TBTT) or a Target Short Beacon Transmission Time (TSBTT) associated with transmission of the protected beacon frame by the second network device.

17. The short frame protection method of claim 14, wherein at least a portion of the integrity value calculated by the second network device is included within or appended to the received short frame received by the first network device.

18. The short frame protection method of claim 14, wherein the received short frame includes a truncated integrity value calculated by the second network device.

19. The short frame protection method of claim 14, wherein:
the integrity value indicated in the received short frame is based on a ceiling of a beacon counter calculation by the second network device;
the expected integrity value computed by the first network device is based on a floor of the beacon counter calculation, wherein the first network device and the second network device perform the same beacon counter calculation each using a respective timer value as an input to the same beacon counter calculation.

20. The short frame protection method of claim 19, wherein computing the expected integrity value comprises:
dividing the respective timer value for the first network device by a beacon interval corresponding to the short frame, to thereby obtain a first calculated value;
determining a counter based on taking a floor of the first calculated value; and
computing the expected integrity value based on the counter.
